(19) United States
(12) Patent Application Publication
(10) Pub. No.: US 2023/0299626 A1
(43) Pub. Date: Sep. 21, 2023

(54) ROTOR LAMINATION, LAMINATED ROTOR CORE, ROTOR, ELECTRICAL MACHINE, AND VEHICLE

(71) Applicant: VALEO EAUTOMOTIVE GERMANY GmbH, Erlangen (DE)

(72) Inventors: Christine BECK, Bad Neustadt a.d. Saale (DE); Florian BEYER, Bad Neustadt a.d. Saale (DE)

(73) Assignee: VALEO EAUTOMOTIVE GERMANY GmbH, Erlangen (DE)

(21) Appl. No.: 18/006,076

(22) PCT Filed: Jun. 23, 2021
(86) PCT No.: PCT/EP2021/067060

§ 371 Date: Jan. 19, 2023

(30) Foreign Application Priority Data
Jul. 22, 2020 (DE) 10 2020 119 296.7

(51) Int. Cl. H02K 1/276

(52) U.S. Cl. CPC H02K 1/276

(57) ABSTRACT

A rotor lamination for a rotor of an electrical machine includes a large number of passage openings each intended to form a magnet pocket of a rotor laminated core and having a first longitudinal side and a second longitudinal side parallel to the first longitudinal side. For pairs of passage openings adjacent in the circumferential direction and situated axially symmetrically with respect to a radial axis of symmetry, an outer contour of a respective passage opening of a respective pair connects ends, pointing to the axis of symmetry, of the longitudinal sides to one another. The outer contour extends from the first longitudinal side in a direction which is averted from the two longitudinal sides, and runs over an arcuate portion, which is curved towards the axis of symmetry, to the second longitudinal side along a direction of extent defined from the first to second longitudinal side.

The present invention relates to a rotor lamination for a rotor of an electrical machine, comprising a large number of passage openings, each of which is intended to form a magnet pocket of a rotor laminated core and has a first longitudinal side and a second longitudinal side parallel to the first longitudinal side, wherein, for pairs of passage openings adjacent in the circumferential direction and situated axially symmetrically in relation to one another with respect to a radial axis of symmetry, an outer contour of a respective passage opening of a respective pair connects ends, pointing to the axis of symmetry, of the longitudinal sides to one another.

In addition, the invention relates to a rotor laminated core for an electrical machine, to a rotor for an electrical machine, to an electrical machine for a vehicle and to a vehicle.

DE 10 2018 118 275 A1 discloses a rotor arrangement for an electrical machine, comprising a rotor core, formed by a laminated core, and a plurality of permanent magnets, each of which is arranged inside a magnet pocket formed in the rotor core so as to form a clearance extending in the axial direction. A plurality of magnet pocket arrangements each comprising a plurality of the magnet pockets are formed here, wherein each magnet pocket arrangement comprises two radially spaced-apart pairs of magnet pockets arranged in a V shape.

Rotor laminations sometimes have to withstand large mechanical loads during operation of a rotor formed by them, in particular in heavily utilized electrical machines for automotive applications. These large mechanical loads are produced in particular due to a volume force or centrifugal force acting on the rotor lamination during rotation, due to a surface force or a contact pressure which results from a press fit of the rotor lamination on a shaft, and additional surface loads which act on the rotor lamination because permanent magnets are arranged in magnet pockets of the rotor and are supported against radial displacement. The combination of loads of this kind leads to a local peak value for a mechanical stress in a web between the outer contours of a pair of symmetrical passage openings. The wider this web, the lower the risk of material failure on account of the mechanical stresses. However, on the other hand, the web should be as narrow as possible in order to keep magnetic saturation in the region of the web low.

Therefore, the invention is based on the object of specifying a way of reducing mechanical stresses in a region of opposing outer contours of symmetrical magnet pockets.

According to the invention, this object is achieved by a rotor lamination for a rotor of an electrical machine, comprising a large number of passage openings, each of which is intended to form a magnet pocket of a rotor laminated core and has a first longitudinal side and a second longitudinal side parallel to the first longitudinal side, wherein, for pairs of passage openings adjacent in the circumferential direction and situated axially symmetrically in relation to one another with respect to a radial axis of symmetry, an outer contour of a respective passage opening of a respective pair connects ends, pointing to the axis of symmetry, of the longitudinal sides to one another, wherein the outer contour extends from the first longitudinal side in a direction which is averted from the two longitudinal sides, and runs over an arcuate portion, which is curved towards the axis of symmetry, to the second longitudinal side along a direction of extent defined from the first longitudinal side to the second longitudinal side.

The rotor lamination according to the invention for a rotor of an electrical machine consequently comprises a large number of passage openings. Each of the passage openings is intended to form a magnet pocket of a rotor laminated core. Each of the passage openings has a first longitudinal side and a second longitudinal side parallel to the first longitudinal side. For pairs of passage openings adjacent in the circumferential direction and situated axially symmetrically in relation to one another with respect to a radial axis of symmetry, an outer contour of a respective passage opening of a respective pair connects ends, pointing to the axis of symmetry, of the longitudinal sides to one another. The outer contour extends from the first longitudinal side in a direction which is averted from the two longitudinal sides. The outer contour runs over an arcuate portion, which is curved towards the axis of symmetry, along a direction of extent defined from the first longitudinal side to the second longitudinal side.

The invention is based on the knowledge that high mechanical stresses are formed in particular in such regions of the outer contour which, on account of their small radius, cause a high notch effect since the notch effect rises as the radius drops. Since, according to the invention, the outer contour initially extends away from the longitudinal sides and then runs back to the second longitudinal side over the arcuate portion, a larger value for a minimum radius of the arcuate portion can be achieved in the region of a web between the outer contours of the passage openings of a respective pair.

In comparison to a conventional rotor lamination, in which the outer contour does not initially extend in the direction averted from the two longitudinal sides, the local maximum for the mechanical stress in the region of the web can therefore advantageously be reduced. Given the same mechanical stress resistance capacity of the rotor lamination, said rotor lamination can firstly withstand a higher volume force, in particular owing to higher rotation speeds, and secondly higher surface forces, in particular owing to the use of more powerful, heavier permanent magnets. Alternatively, given the same surface and physical forces occurring, a more cost-effective, less stress-resistant material can be used. In this case, the above-described geometry of the outer contour can be employed given a large number of known shapes and arrangements of magnet pockets

The rotor lamination is typically formed from a soft-magnetic material. The rotor lamination expediently has a central cutout for being secured on a shaft, in particular by means of a press fit. A web (or in other words a bridge) of the rotor lamination is typically formed between the outer contours of a respective pair of passage openings. The rotor lamination preferably has at least four, preferably at least six, pairs of passage openings arranged equidistantly in the circumferential direction.

The distance between the longitudinal sides is generally smaller than the length of a respective longitudinal side. The ends of the longitudinal sides are typically situated substantially on a straight line which is perpendicular to the longitudinal sides. A permanent magnet preferably extends inside the magnet pocket or the passage opening in the direction of the axis of symmetry at most as far as the end of the longitudinal sides. Therefore, magnets with a, possibly rounded, rectangular cross section are typically used, wherein longitudinal sides of the permanent magnets extend parallel to the longitudinal sides of the passage openings. The outer contour typically delimits an air pocket in the magnet pocket. A further air pocket can be formed at the ends of the longitudinal sides situated opposite the outer contour.

In the rotor lamination according to the invention, it is preferred when the arcuate portion has a first sub-portion and a second sub-portion, wherein a minimum radius of the first sub-portion is larger than a minimum radius of the second sub-portion. As a result, a maximum for the mechanical stresses can advantageously be moved into the region of the second sub-portion, which has the smaller minimum radius.

It is preferred when the first sub-portion is located in front of the second sub-portion with respect to the direction of extent. This allows the outer contour to be guided along the arcuate portion initially with the larger minimum radius and therefore with a small notch effect to the point of the smallest distance between the outer contours of the passage openings of a pair and then along the second sub-portion with the smaller minimum radius in the direction of the second longitudinal side.

In principle, it is conceivable for the sub-portions to be of elliptical or some other arcuate design. However, it is particularly preferred when the first sub-portion is in the form of an arc of a circle and/or the second sub-portion is in the form of an arc of a circle. The minimum radius of a respective sub-portion is then a constant value of the radius of the corresponding sub-portion.

The second sub-portion preferably directly adjoins the first sub-portion. The first sub-portion preferably transitions smoothly into the second sub-portion. A point of the smallest distance between the outer contours of the passage openings of a respective pair is preferably situated in the second sub-portion.

In the rotor lamination according to the invention, provision can further be made for the outer contour to have a straight portion between the end of the first longitudinal side and the arcuate portion. The outer contour can be guided away from the two longitudinal sides over a short distance in this way in order to implement the desired increase in size of the minimum radius of the arcuate portion.

In a particularly preferred development, provision is made for a straight line along which the first longitudinal side runs and a straight line along which the straight portion runs to intersect substantially at a right angle, the limbs of which angle run along the first longitudinal side and the straight portion. Owing to the substantially right-angled profile, firstly an undesired reduction in size of the air pocket can be prevented if the angle is substantially greater than 90° and secondly negative influencing of the magnetic field line profile can be avoided if the angle is substantially greater than 90°. In particular, “substantially at a right angle” is intended to be understood to mean an angular range of between 85° and 95°, preferably of between 87° and 93°, particularly preferably of between 89° and 91°. However, the angle is additionally preferably at most 90°.

In respect of manufacture, it is advantageous, in principle, when a transition between the first longitudinal side and the straight portion and/or a transition between the straight portion and the arcuate portion is of rounded design, in particular with a smaller radius than the minimum radius of the second sub-portion.

According to a first preferred variant refinement of the rotor lamination according to the invention, provision is made for the arcuate portion to end between two straight lines along which the longitudinal sides extend and for the outer contour to have a projecting portion, which preferably runs in a straight line, with respect to the direction of extent on the other side of the arcuate portion. Such a projecting portion makes it easier to position the permanent magnets in the passage openings during manufacture. The projecting portion is designed to prevent a movement of the permanent magnets along the longitudinal sides.

In respect of manufacture, provision can also advantageously be made here for a transition between the arcuate portion and the projecting portion and/or a transition between the projecting portion and the second longitudinal side to be of rounded design, in particular with a smaller curve radius than the second curve radius.

According to an alternative variant refinement of the rotor lamination according to the invention, provision is made for the arcuate portion to transition smoothly into the second longitudinal side or into a transition portion of the outer contour which extends towards the second longitudinal side in a manner averted from the two longitudinal sides. Consequently, the arcuate portion can pass directly into the second longitudinal side or even beyond a straight line along which the second longitudinal side extends, so that a yet further increase in the minimum radius of the arcuate portion is possible. However, such a configuration of the outer contour generally requires the permanent magnets inserted into the passage opening to have to be kept active when they are secured to the magnet pockets.

In an advantageous development of the rotor lamination according to the invention, the end of the first longitudinal side is situated radially further on the inside than the end of the second longitudinal side. This has the effect that the outer contour initially extends in the radially inner direction in order to achieve a sufficient width of the web.

In the rotor lamination according to the invention, provision is made in a preferred refinement for the passage openings of the pairs to be arranged in a V shape open radially to the outside. Therefore, a number of rotor poles corresponding to the number of pairs of passage openings can advantageously be formed in this way. An angle, of which the limbs extend along the axis of symmetry and the first longitudinal side, is typically less than 90°, preferably less than 75°, particularly preferably less than 65°, and/or greater than 20°, preferably greater than 45°, particularly preferably greater than 50°.

In a preferred development, a double-V arrangement of the permanent magnets is implemented when the rotor lamination for each of the pairs has a pair of further passage openings which are arranged in a V shape open to the outside and axially symmetrically with respect to the axis of symmetry. The longitudinal sides of the further passage openings are typically shorter than those of the passage openings. Moreover, all the preceding statements made in respect of the passage openings can be applied to the further passage openings.

Alternatively or additionally, a delta arrangement of passage openings can be implemented when the rotor lamination for each of the pairs has a further passage opening which extends perpendicularly to the axis of symmetry.

In a preferred refinement, provision is made for a radially innermost point of the or a respective further passage opening to be situated radially further on the outside than a radially innermost point of the passage openings.

It is further possible for the pairs of passage openings to each be formed from two passage openings directly adjacent in the circumferential direction, wherein the centres of the longitudinal sides are perpendicular to the radial direction. In this case, each pair of passage openings typically forms magnet pockets for two adjacent rotor poles.

The object on which the invention is based is further achieved by a rotor laminated core for an electrical machine, comprising a large number of rotor laminations according to the invention arranged in an axially layered manner. The rotor laminations are expediently arranged in such a way that the magnet pockets form receiving spaces for the permanent magnets, the receiving spaces being continuous in the axial direction. The rotor laminations are typically electrically insulated from one another. It is further preferred when the rotor laminations are connected to one another in a rotationally fixed manner, for example by integral bonding, preferably weld seams which are formed on a lateral surface of the rotor laminated core.

The object on which the invention is based is further achieved by a rotor for an electrical machine, comprising a rotor laminated core according to the invention, wherein permanent magnets are arranged in the magnet pockets. It is possible for precisely one permanent magnet or a plurality of permanent magnets arranged in an axially layered manner to be arranged in each magnet pocket. The permanent magnets are typically potted in the magnet pockets.

The object on which the invention is based is further achieved by an electrical machine for a vehicle, comprising a stator and a rotor according to the invention, wherein the rotor is rotatably mounted inside the stator. The electrical machine according to the invention can be, in particular, an electric motor. The electrical machine according to the invention is preferably a three-phase machine, in particular a permanently excited synchronous machine.

In addition, the object on which the invention is based is achieved by a vehicle, comprising an electrical machine according to the invention which is designed to drive the vehicle. Consequently, the vehicle according to the invention may be a battery-electric vehicle (BEV) or a hybrid vehicle.

Further advantages and details of the present invention can be found in the exemplary embodiments described below and on the basis of the drawings. The latter are schematic illustrations in which:

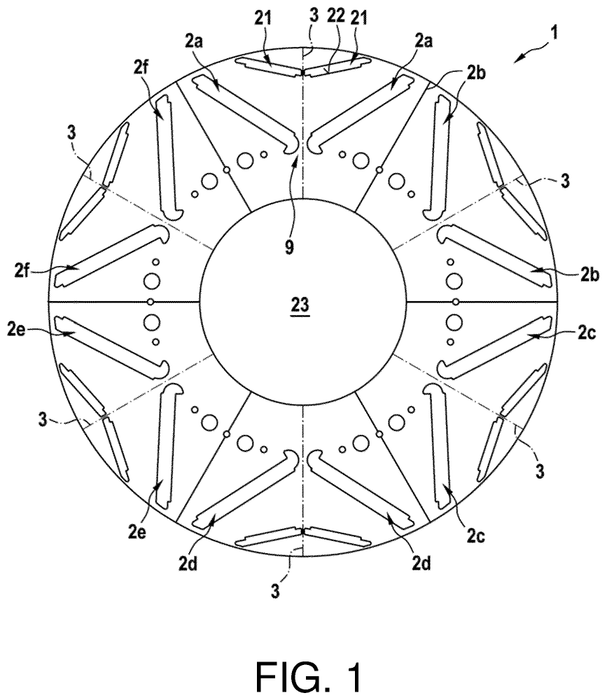

FIG. 1 shows a plan view of a first exemplary embodiment of the rotor lamination according to the invention;

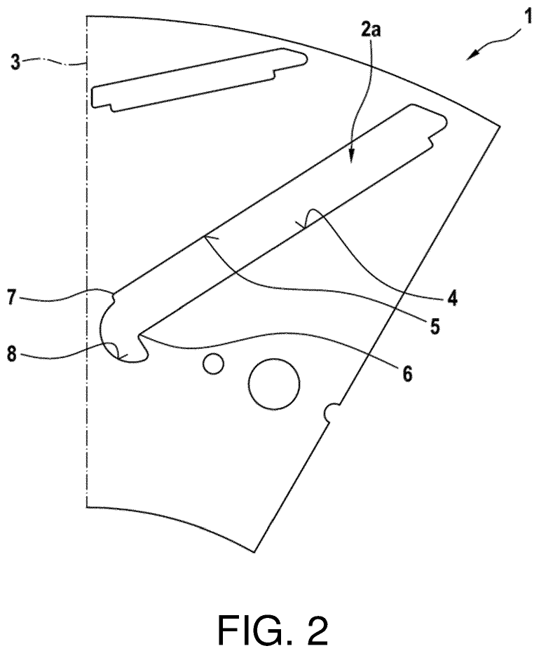

FIG. 2 shows a view of a detail of a sector of the rotor lamination shown in FIG. 1;

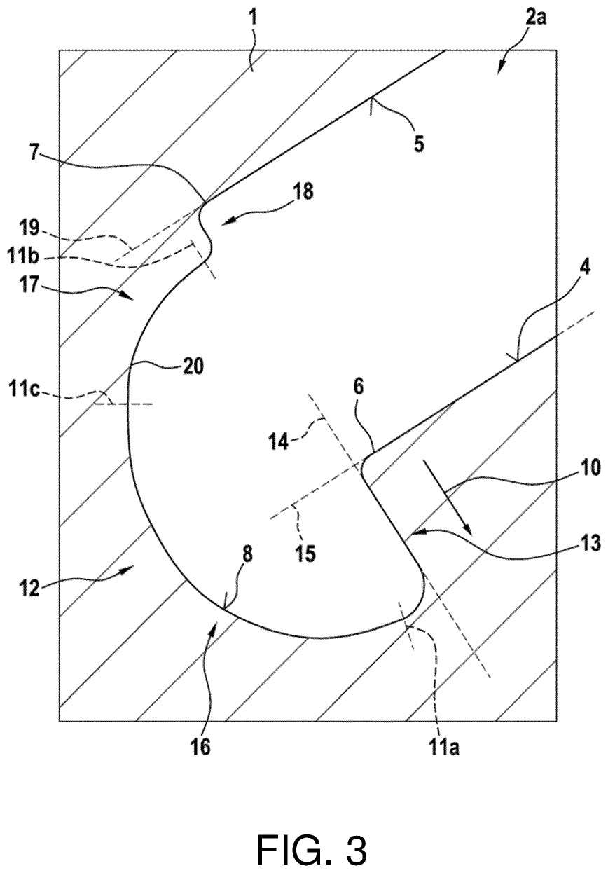

FIG. 3 shows a view of a detail of the outer contour of a passage opening of the rotor lamination shown in FIG. 1;

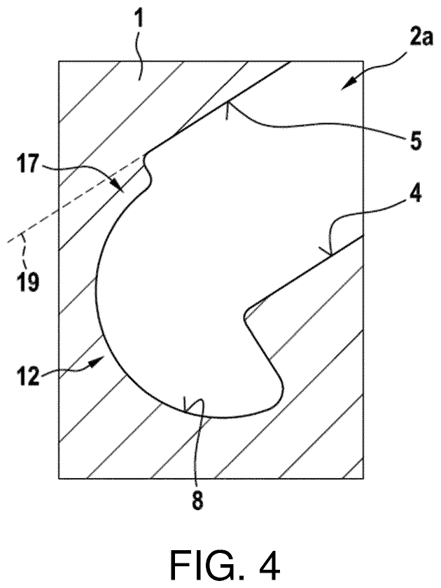

FIG. 4 shows a view of a detail of the outer contour according to a second exemplary embodiment of the rotor lamination according to the invention;

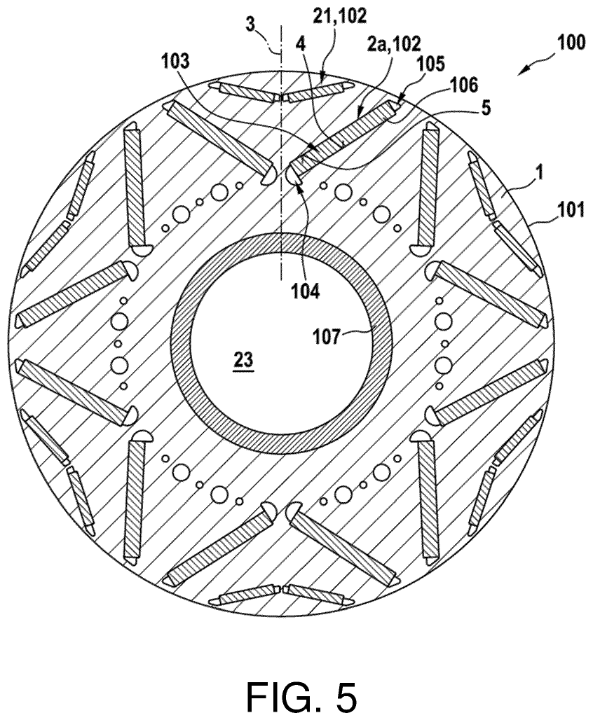

FIG. 5 shows a sectioned view of an exemplary embodiment of the rotor according to the invention having an exemplary embodiment of the rotor laminated core according to the invention; and

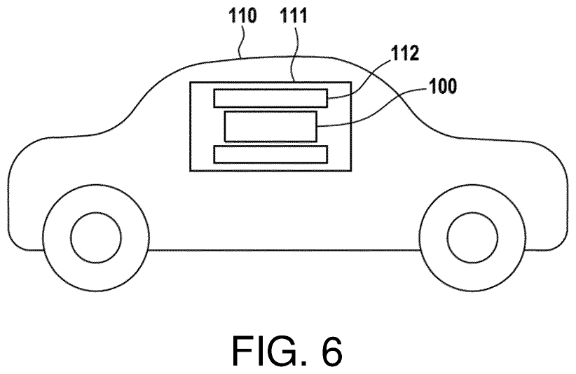

FIG. 6 shows a basic diagram of an exemplary embodiment of the vehicle according to the invention having an exemplary embodiment of the electrical machine according to the invention.

FIG. 1 and FIG. 2 show a plan view of a first exemplary embodiment of a rotor lamination 1, where FIG. 2 is a view of a detail of a sector of the rotor lamination 1.

The rotor lamination 1 comprises a large number of passage openings 2a to 2f, each of which is intended to form a magnet pocket of a rotor laminated core. Six pairs of passage openings 2a to 2f directly adjacent in the circumferential direction are provided in the present exemplary embodiment. The passage openings 2a to 2f forming a respective pair are situated axially symmetrically in relation to one another with respect to a radial axis of symmetry 3.

As can be seen in particular from FIG. 2, which representatively shows a passage opening 2a, each passage opening 2a to 2f has a first longitudinal side 4 and a second longitudinal side 5 parallel to said first longitudinal side, wherein the first longitudinal side 4 has an end 6 pointing to the axis of symmetry 3 and the second longitudinal side 5 has an end 7 pointing to the axis of symmetry 3. The ends 6, 7 are situated on a straight line running perpendicularly to the longitudinal sides 4, 5. The ends 6, 7 are connected to one another by an outer contour 8, so that a web 9 (see FIG. 1) is formed between the outer contours 8 of the passage openings 2a to 2f of a respective pair.

FIG. 3 shows a view of a detail of the outer contour 8 of the passage opening 2a shown in FIG. 2.

As can be seen, the outer contour 8 extends from the end 6 of the first longitudinal side 4 in a direction symbolized by an arrow 10 and averted from the two longitudinal sides 4, 5, and over an arcuate portion 12, identified by dashed boundary lines 11a, 11b, to the second longitudinal side 5 or its end 7. A direction of extent of the outer contour 8 is defined here from the first longitudinal side 4 to the second longitudinal side 5.

The outer contour 8 first has a straight portion 13 between the end 6 of the first longitudinal side 4 and the arcuate portion 12. The straight portion 13 extends in the direction (see arrow 10) averted from the two longitudinal sides 4, 5 along a straight line 14 which is at a right angle to a straight line 15 along which the first longitudinal side 4 extends. Here, transitions are formed in a rounded manner between the first longitudinal side 4 and the straight portion 13 and between the straight portion 13 and the arcuate portion 12.

The arcuate portion 12 has a first sub-portion 16 and a second sub-portion 17, wherein the first sub-portion 16 is situated in front of the second sub-portion 17 with respect to the direction of extent. The sub-portions 16, 17 directly adjoin one another, this being identified by a boundary line 11c. The sub-portions 16, 17 are each in the form of an arc of a circle, with the radius of the first sub-portion 16 being larger than that of the second sub-portion 17. Here, the sub-portions 16, 17 transition smoothly into one another at the location of the boundary line 11c.

On the other side of the arcuate portion 12, the outer contour 8 has a projecting portion 18 running in a straight line. The projecting portion 18 is situated between the straight line 15 and a straight line 19 along which the second longitudinal side 5 extends. The projecting portion 18 extends perpendicularly to the straight line 19. Transitions between the arcuate portion 12 and the projecting portion 18 and between the projecting portion 18 and the second longitudinal side 5 are of rounded design.

With reference to FIG. 1, it can be seen that, for the rotor lamination 1, the passage openings 2a to 2f of the pairs are arranged in a V-shape open radially to the outside. In this case, the straight lines 15, 19 (see FIG. 3), along which the longitudinal sides 4, 5 extend, enclose an angle of approximately 58° with the axis of symmetry 3. For each of the pairs of passage openings 2a to 2f, further passage openings 21 are further provided, which are arranged in a V-shape open to the outside and axially symmetrically with respect to the axis of symmetry 3. The further passage openings 21 are arranged radially further on the outside than the passage openings 2a to 2f, in particular a radially innermost point of the further passage openings 21 is situated radially further on the outside than a radially innermost point of the passage openings 2a to 2f. Furthermore, parallel longitudinal sides 22 of the further passage openings 21 are shorter than the longitudinal sides 4, 5 of the passage openings 2a to 2f. A double-V arrangement of the passage openings 2a to 2f, 21 is implemented in this way.

Finally, FIG. 1 also further shows a central cutout 23 of the rotor lamination 1, it being possible for a shaft to be passed through said central cutout. Here, the central cutout 23 is circular by way of example. However, it may also have a different shape, for example have opposite parallel portions which are connected by opposite portions in the form of an arc of a circle.

FIG. 4 shows a view of a detail of the outer contour 8 according to a second exemplary embodiment of a rotor lamination 1. All the statements made in respect of the first exemplary embodiment can be applied to the second exemplary embodiment, provided nothing to the contrary is described hereinafter. Components that are the same or have the same effect are provided with identical reference signs here.

In the second exemplary embodiment, the outer contour 8 of the passage opening 2a does not have a projecting portion. The arcuate portion 12 or its second sub-portion 17 transition smoothly into the second longitudinal side 5. Such an outer contour 8 is expedient, for example, if permanent magnets do not have to be prevented from moving along the longitudinal sides by a projecting portion during the manufacture of a rotor because the permanent magnets are held in some other way.

According to a further exemplary embodiment of a rotor lamination which otherwise corresponds to the second exemplary embodiment, the arcuate portion 12 extends beyond the straight line 19 in a direction averted from the two longitudinal sides 4, 5 and then transitions into the second longitudinal side 5. In such an exemplary embodiment, in particular the centres of the longitudinal sides 4, 5 can be arranged perpendicularly to the radial direction.

According to a further exemplary embodiment of a rotor lamination 1 which otherwise corresponds to the first exemplary embodiment or the second exemplary embodiment, for each pair of passage openings 2a to 2f, a further passage opening, of which the longitudinal sides are perpendicular to the axis of symmetry 3, is provided instead of the further passage openings 21 arranged in a V-shape. A delta arrangement of the passage openings can be formed in this way.

FIG. 5 shows a sectioned view of an exemplary embodiment of a rotor 100 having an exemplary embodiment of a rotor laminated core 101 according to the invention.

The rotor laminated core 101 is formed from a large number of axially layered rotor laminations 1 according to the first exemplary embodiment electrically insulated from one another. The passage openings 2a to 2f, 21, of which only one passage opening 2a and one further passage opening 21 are provided with reference signs in FIG. 5 for reasons of clarity, of the rotor laminations 1 are situated congruently one above the other here, so that magnet pockets 102, which extend axially through the rotor laminated core 101, are formed. Here, each magnet pocket 102 comprises a receiving space 103 between the longitudinal sides 4, 5 and an air pocket 104 delimited by the outer contour 8 and pointing to the axis of symmetry 3. A further air pocket 105 is formed at the ends of the longitudinal sides 4, 5 opposite the air pocket 104. The rotor laminations 1 are connected in a rotationally fixed manner by way of example integrally, for example by laser welding.

The rotor 100 further comprises a large number of permanent magnets 106 which are arranged in the magnet pockets 102 and pass through the receiving space 103 of a respective magnet pocket 102. Here, a single permanent magnet 106 or a large number of permanent magnets 106 arranged axially one behind the other can be arranged in each magnet pocket 102. There is no permanent magnet in the air pockets 104, 105. The air pockets 104, 105 and intermediate spaces between the permanent magnets and the longitudinal sides 4, 5 are filled with a resin.

In addition, the rotor 100 comprises a rotor shaft 107 which passes through the central cutout 23 in the rotor laminations 1. In the present case, the rotor shaft 107 is in the form of a hollow shaft by way of example.

Further exemplary embodiments of the rotor 100 comprise a large number of rotor laminations 1 according to the further exemplary embodiments.

FIG. 6 shows a schematic diagram of an exemplary embodiment of a vehicle 110 having an exemplary embodiment of an electrical machine 111.

The electrical machine 111 comprises a stator 112 and a rotor 100 according to one of the exemplary embodiments described above rotatably mounted inside the stator 112. The electrical machine 111 is a permanently excited synchronous machine and is in the form of an electric motor. The electrical machine 111 is designed to drive the vehicle 110 which is, for example, a battery-electric vehicle (BEV) or a hybrid vehicle.

1. Rotor lamination for a rotor of an electrical machine, comprising a large number of passage openings, each of which is intended to form a magnet pocket of a rotor laminated core and has a first longitudinal side and a second longitudinal side parallel to the first longitudinal side, wherein, for pairs of passage openings adjacent in the circumferential direction and situated axially symmetrically in relation to one another with respect to a radial axis of symmetry, an outer contour of a respective passage opening of a respective pair connects ends, pointing to the axis of symmetry, of the longitudinal sides to one another, and wherein
the outer contour extends from the first longitudinal side in a direction which is averted from the two longitudinal sides, and runs over an arcuate portion, which is curved towards the axis of symmetry, to the second longitudinal side along a direction of extent defined from the first longitudinal side to the second longitudinal side.

2. Rotor lamination according to claim 1, wherein the arcuate portion has a first sub-portion and a second sub-portion, wherein a minimum radius of the first sub-portion is larger than a minimum radius of the second sub-portion.

3. Rotor lamination according to claim 2, wherein the first sub-portion is located in front of the second sub-portion with respect to the direction of extent.

4. Rotor lamination according to claim 2, wherein the first sub-portion is in the form of an arc of a circle and/or the second sub-portion is in the form of an arc of a circle.

5. Rotor lamination according to claim 1, wherein
the outer contour has a straight portion between the end of the first longitudinal side and the arcuate portion.

6. Rotor lamination according to claim 5, wherein a straight line along which the first longitudinal side runs and a straight line along which the straight portion runs intersect substantially at a right angle.

7. Rotor lamination according to claim 1, wherein
the arcuate portion ends between two straight lines along which the longitudinal sides extend and the outer contour has a projecting portion, which preferably runs in a straight line, with respect to the direction of extent on the other side of the arcuate portion.

8. Rotor lamination according to claim 1, wherein
the arcuate portion transitions smoothly into the second longitudinal side or into a transition portion of the outer contour which extends towards the second longitudinal side in a manner averted from the two longitudinal sides.

9. Rotor lamination according to claim 1, wherein
the end of the first longitudinal side is situated radially further on the inside than the end of the second longitudinal side.

10. Rotor lamination according to claim 1, wherein
the passage openings of the pairs are arranged in a V shape open radially to the outside.

11. Rotor lamination according to claim 9, wherein the rotor lamination
for each of the pairs has a pair of further passage openings which are arranged in a V shape open to the outside and axially symmetrically with respect to the axis of symmetry and/or
for each of the pairs has a further passage opening which extends perpendicularly to the axis of symmetry,
wherein a radially innermost point of the or a respective further passage opening is situated radially further on the outside than a radially innermost point of the passage openings.

12. Rotor laminated core for an electrical machine, comprising a large number of rotor laminations according to claim 1 arranged in an axially layered manner.

13. Rotor for an electrical machine, comprising a rotor laminated core according to claim 12, wherein permanent magnets are arranged in the magnet pockets.

14. Electrical machine for a vehicle, comprising a stator and a rotor according to claim 13, wherein the rotor is rotatably mounted inside the stator.

15. Vehicle, comprising an electrical machine according to claim 14 which is designed to drive the vehicle.

16. Rotor lamination according to claim 3, wherein the first sub-portion is in the form of an arc of a circle and/or the second sub-portion is in the form of an arc of a circle.

17. Rotor lamination according to claim 2, wherein the outer contour has a straight portion between the end of the first longitudinal side and the arcuate portion.

18. Rotor lamination according to claim 2, wherein the arcuate portion ends between two straight lines along which the longitudinal sides extend and the outer contour has a projecting portion, which preferably runs in a straight line, with respect to the direction of extent on the other side of the arcuate portion.

19. Rotor lamination according to claim 2, wherein the arcuate portion transitions smoothly into the second longitudinal side or into a transition portion of the outer contour which extends towards the second longitudinal side in a manner averted from the two longitudinal sides.

20. Rotor lamination according to claim 2, wherein the end of the first longitudinal side is situated radially further on the inside than the end of the second longitudinal side.
